(19) United States
(12) Patent Application Publication
(10) Pub. No.: US 2025/0061711 A1
(43) Pub. Date: Feb. 20, 2025

(54) METHOD, COMPUTER DEVICE AND COMPUTER-READABLE STORAGE MEDIUM FOR AUTOMATICALLY OBTAINING FACTORS RELATED TO TRAFFIC ACCIDENTS BASED ON TRAFFIC VIDEOS

(71) Applicant: MITAC Digital Technology Corporation, Taoyuan City (TW)

(72) Inventors: Chih-Pei LIU, Taoyuan City (TW); Yu-Sheng CHANG, Taoyuan City (TW); Hsiao-Yang Lee, Taoyuan City (TW); Chuang-Chiang Dai, Taoyuan City (TW)

(21) Appl. No.: 18/801,939

(22) Filed: Aug. 13, 2024

(30) Foreign Application Priority Data
Aug. 14, 2023 (TW) 112130429

(51) Int. Cl. G06V 20/40; G06F 40/18; G06V 20/54; G06V 20/59; G08G 1/01; G08G 1/04; G08G 1/16

(52) U.S. Cl. CPC G06V 20/41; G06V 20/54; G06V 20/597; G08G 1/0133; G08G 1/04; G08G 1/16; G06F 40/18; G06V 2201/08

(57) ABSTRACT

A method for automatically obtaining factors related to traffic accidents includes: in case that a traffic accident is identified in a traffic video, categorizing the traffic accident into one of a plurality of pre-determined categories; collecting, first factoring data and second factoring data contained in the traffic video within an accident-related time period, tagging the traffic video as a traffic accident video with the one of the pre-determined categories, and storing the traffic accident video, the first factoring data and the second factoring data in a data storage; compiling a factor group for the traffic accident video based on the first factoring data and the second factoring data, and aggregating a plurality of factor groups of traffic accident videos to create aggregated factor groups; and creating a spreadsheet that contains the aggregated factor groups and that can be sorted using geographical locations.

### CROSS-REFERENCE TO RELATED APPLICATION

This application claims priority to Taiwanese Invention Patent Application No. 112130429, filed on Aug. 14, 2023, the entire disclosure of which is incorporated by reference herein.

### FIELD

The disclosure relates to a method, a computer device and a computer-readable storage medium for automatically obtaining factors related to traffic accidents and predicting traffic accidents based on a plurality of traffic videos.

### BACKGROUND

Driving video recorders are widely installed on vehicles for recording videos of the surrounding of the vehicles while the vehicles are being driven, so that details in the surrounding of the vehicles that the drivers of the vehicles are not aware of may be recorded. In addition, traffic cameras are also widely installed in different road sections and intersections for recording videos. In case a traffic accident occurs, the videos recorded by nearby vehicles and by the traffic cameras may be obtained and viewed by an authority to assist in determining which party(ies) is(are) liable for the traffic accident.

It is noted that in some cases, the number of videos involved in a traffic accident may be relatively large, and a total duration of video lengths may be relatively long. As such, the authority viewing the videos may not be able to notice all the details that are recorded in the videos, and therefore may not be able to make an accurate judgement on how the traffic accident has occurred and/or which party(ies) is(are) liable for causing the traffic accident.

It is noted that one prominent cause of traffic accidents is related to the drivers of the vehicles. For example, some drivers may be distracted by other things, intoxicated, or is mind-wandering, however, the above expressions are sometimes very subtle and not obvious.

### SUMMARY

Additionally, it may be beneficial to obtain a large number of videos that are related to traffic accidents, and to process the videos for automatically analyzing the video, sorting out the possible factor(s) that may lead to the traffic accidents, and predicting when a traffic accident might occur based on the possible factor(s), using the now commercially available artificial intelligence (AI) techniques. As such, the drivers may be notified with potential traffic accidents in advance, which may be helpful in reducing the occurrence of the traffic accidents.

Therefore, one object of the disclosure is to provide a method for automatically obtaining factors related to traffic accidents.

According to one embodiment of the disclosure, the method is implemented using a computer device that includes a processor and a data storage, the data storage storing a plurality of traffic videos. The method includes:
a) processing, by the processor, each of the plurality of traffic videos so as to determine, for each of the traffic videos, whether a traffic accident is identified therein, and in the case that a traffic accident is identified in one of the traffic videos, categorizing the traffic accident into one of a plurality of pre-determined categories;
b) collecting, by the processor for each of the traffic videos in which the traffic accidents are identified, first factoring data associated with the traffic accident recorded in the traffic video within an accident-related time period associated with a time instance at which the traffic accident occurred, tagging the traffic video as a traffic accident video with the one of the pre-determined categories, and storing the traffic accident video and the associated first factoring data in the data storage, the first factoring data including information associated with one of a vehicle, a pedestrian, a traffic sign and combinations thereof;
c) processing, by the processor, each of the traffic accident videos stored in the data storage so as to collect, for each of the traffic accident videos, second factoring data that is different from the first factoring data and that is contained in the traffic accident video within the accident-related time period, the second factoring data including information associated with at least geographical information and weather information;
d) compiling, by the processor, a factor group for each of the traffic accident videos based on the first factoring data and the second factoring data, and aggregating the factor groups to create aggregated factor groups; and
e) creating, by the processor, a spreadsheet that contains the aggregated factor groups generated in step d) and that can be sorted using geographical locations.

Another object of the disclosure is to provide a computer device that is capable of implementing the above-mentioned method.

According to one embodiment of the disclosure, the computer device for automatically obtaining factors related to traffic accidents includes a processor and a data storage connected to the processor. The data storage stores a plurality of traffic videos. The processor is configured to process each of the plurality of traffic videos so as to determine, for each of the traffic videos, whether a traffic accident is identified therein, and in the case that a traffic accident is identified in one of the traffic videos, categorizes the traffic accident into one of a plurality of pre-determined categories.

The processor is configured to collect, for each of the traffic videos in which the traffic accidents are identified, first factoring data associated with the traffic accident recorded in the traffic video within an accident-related time period associated with a time instance at which the traffic accident occurred, tag the traffic video as a traffic accident video with the one of the pre-determined categories, and store the traffic accident video and the associated first factoring data in the data storage. The first factoring data includes information associated with one of a vehicle, a pedestrian, a traffic sign and combinations thereof.

The processor is configured to processes each of the traffic accident videos stored in the data storage so as to collect, for each of the traffic accident videos, second factoring data that is different from the first factoring data and that is contained in the traffic accident video within the accident-related time period. The second factoring data includes information associated with at least geographical information and weather information.

The processor is configured to compile a factor group for each of the traffic accident videos based on the first factoring data and the second factoring data, and to aggregate the factor groups to create aggregated factor groups. Then, the processor creates a spreadsheet that contains the aggregated factor groups and that can be sorted using geographical locations.

Another object of the disclosure is to provide a non-transitory computer-readable storage medium storing instructions that, when executed by a processor of an electronic device communicating with a plurality of vehicles, cause the processor to perform steps of the above-mentioned method.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a flow chart illustrating steps of a method for automatically obtaining factors related to traffic accidents based on a plurality of traffic videos according to one embodiment the disclosure.

FIG. 2 is a block diagram illustrating an exemplary computer device that is configured to implement the method of FIG. 1 according to one embodiment of the disclosure.

FIG. 3 illustrates the computer device being in communication with a monitoring system according to one embodiment of the disclosure.

FIGS. 4 and 5 are flow charts illustrating steps of a monitoring process according to one embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

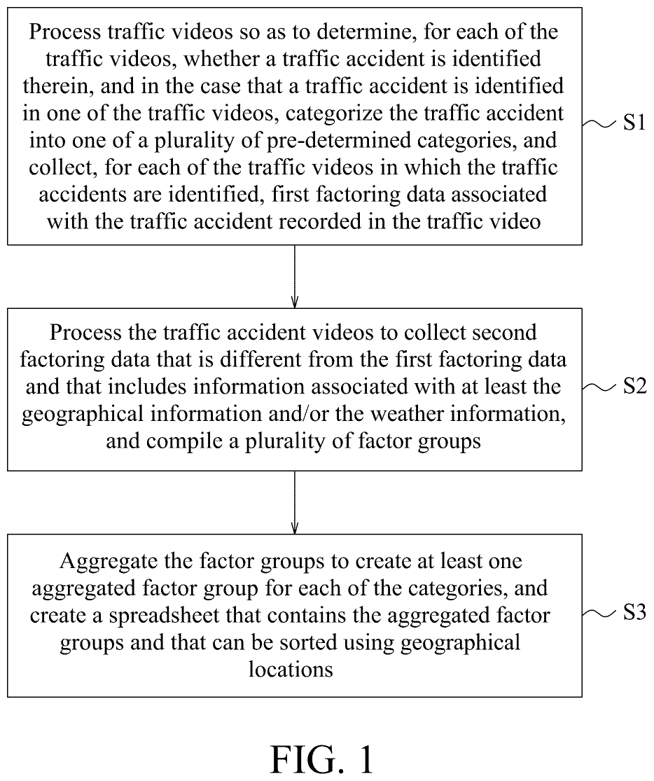

FIG. 1 is a flow chart illustrating steps of a method for automatically obtaining factors related to traffic accidents based on a plurality of traffic videos according to one embodiment of the disclosure. In some embodiments, the method of FIG. 1 is implemented using a computer device.

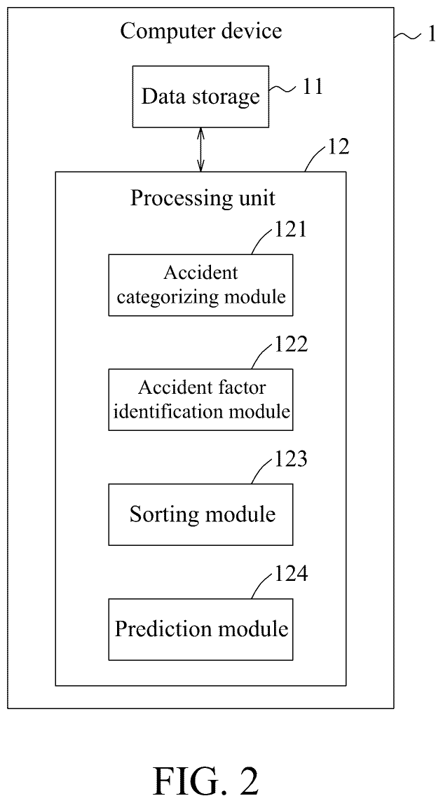

FIG. 2 is a block diagram illustrating an exemplary computer device 1 that is configured to implement the method of FIG. 1 according to one embodiment of the disclosure.

The computer device 1 may be embodied using a server, a personal computer, a laptop, or other suitable computing equipment. The computer device 1 includes a data storage 11, a processing unit 12 and a communication unit 13.

The data storage 11 is connected to the processing unit 12, and may be embodied using, for example, random access memory (RAM), read only memory (ROM), programmable ROM (PROM), firmware, flash memory, etc. In this embodiment, the data storage 11 stores a software application, and includes a traffic video database that stores a plurality of traffic videos therein. The traffic videos may be obtained from various sources such as traffic cameras that are installed in different road sections and intersections, or different vehicle recorders that are installed on different vehicles. In some embodiments, the traffic videos may be provided by different vehicular services such as a bus fleet, a taxi fleet, a tour bus fleet, a tractor truck fleet, etc. It is noted that some of the traffic videos may contain images associated with a traffic accident, and multiple traffic videos may contain images associated with a same traffic accident taken from different angles. In some embodiments, the data storage 11 may further store driver videos that are captured by driver monitoring systems (DMS) installed on some vehicles. Typically, each of the driver videos contains a face image of the driver of a corresponding vehicle.

The processing unit 12 is connected to the data storage 11, and may be embodied using a central processing unit (CPU), a microprocessor, a microcontroller, a single core processor, a multi-core processor, a dual-core mobile processor, a microprocessor, a microcontroller, a digital signal processor (DSP), a field-programmable gate array (FPGA), an application specific integrated circuit (ASIC), and/or a radio-frequency integrated circuit (RFIC), etc. In the embodiment of FIG. 2, the processing unit 12 includes a number of functional blocks. Specifically, the processing unit 12 includes an accident categorizing module 121, an accident factor identification module 122 and a sorting module 123.

It is noted that in some embodiments, each of the functional blocks 121 to 123 may be embodied using a software application that is stored in the data storage 11 and that includes instructions that, when executed by the processing unit 12, cause the processing unit 12 to perform the various operations as described below.

Alternatively, each of the functional blocks 121 to 123 may be integrated in one or more application-specific integrated circuit (ASIC) chips, or one or more programmable logic devices (PLD) included in the processing units 12. As such, the processing unit 12 as a whole is capable of performing the various operations as described below.

Alternatively, the processing unit 12 may be embodied using a microprocessor, and each of the functional blocks 121 to 123 may be embodied using firmware stored in the microprocessor. As such, the processing unit 12 as a whole is capable of performing the various operations as described below.

The communication unit 16 is connected to the processing unit 12, and may include one or more of a radio-frequency integrated circuit (RFIC), a short-range wireless communication module supporting a short-range wireless communication network using a wireless technology of Bluetooth® and/or Wi-Fi, etc., and a mobile communication module supporting telecommunication using Long-Term Evolution (LTE), the third generation (3G), the fourth generation (4G) or the fifth generation (5G) of wireless mobile telecommunications technology, or the like. In use, the communication unit 16 is configured to establish a communication with an external electronic device via a wired or wireless communication.

In use, with the traffic videos being stored in the traffic video database of the data storage 11, it may be desired to process the traffic videos that may be related to traffic accidents for automatically analyzing the videos, sorting out a number of possible factor(s) that may lead to the traffic accidents, and predicting when a traffic accident might occur based on the possible factor(s), using the now commercially available artificial intelligence (AI) techniques. As such, the method of FIG. 1 may be implemented.

Referring to FIG. 1, the method commences with step S1, in which the accident categorizing module 121 executed by the processing unit 12 processes each of the traffic videos so as to determine, for each of the traffic videos, whether a traffic accident is identified therein, and in the case that a traffic accident is identified in one of the traffic videos, the accident categorizing module 121 categorizes the traffic accident into one of a plurality of pre-determined categories.

Specifically, in some embodiments, the accident categorizing module 121 employs a pre-trained neural network for object identification. For example, the neural network may be YOLOv4, a commercially available object detection model, a deep learning model, or other suitable neural networks such as YOLOv1, YOLOv2, YOLOv3, a convolutional neural network (CNN), a region-based CNN (R-CNN), a fast R-CNN, a faster R-CNN, etc.

By processing successive images included in each of the traffic videos, the accident categorizing module 121 is able to identify moving objects in the images (e.g., vehicles, pedestrians, bikers, motorcycle riders, animals, etc.), stationary objects (traffic lights, trees, traffic islands, land line segments, etc.), smoke, or other relevant objects that are helpful in identifying the traffic accident. By identifying the moving objects in the successive images, the accident categorizing module 121 is able to determine a moving track and a velocity for each of the moving objects.

Then, the accident categorizing module 121 is configured to determine whether a traffic accident has occurred in one of the traffic videos by identifying at least one abnormal occurrence related to the traffic video. Specifically, the abnormal occurrence may be one or more of: a velocity of a vehicle having a steep drop (indicating a sudden brake), a severe change of direction of a vehicle, a collision of two separate objects, etc. In different embodiments, the accident categorizing module 121 may determine that a traffic accident has occurred when one or more abnormal occurrences are detected.

Then, in the case that it is determined that a traffic accident has occurred, the accident categorizing module 121 categorizes the traffic accident into one of the plurality of pre-determined categories. In some embodiments, the pre-determined categories includes a first category, in which at least one vehicle and at least one non-vehicle moving object (e.g., a pedestrian, an animal, etc.) are involved, a second category, in which at least two vehicles (including cars, motorcycles, etc.) are involved (indicating a vehicle-to-vehicle collision), and a third category, in which a vehicle and a stationary object are involved (indicating a collision with buildings or a lane departure crash).

Afterward, the accident categorizing module 121 collects, for each of the traffic videos in which the traffic accidents are identified, first factoring data associated with the traffic accident recorded in the traffic video. In some embodiments, the accident categorizing module 121 may determine a time instance at which the traffic accident occurred, and records data of all objects detected in the traffic video within an accident-related time period associated with the time instance (e.g., from 30 seconds prior to the time instance to 30 seconds after the time instance) as the first factoring data. Specifically, for each of the moving objects, the accident categorizing module 121 may collect a type of the moving object, a movement track and a velocity associated with the moving object, etc. For each of the stationary objects, the accident categorizing module 121 may collect a type of the stationary object, a location of the stationary object, etc. Generally, the first factoring data includes information associated with at least one vehicle, at least one pedestrian and/or at least one traffic sign.

Then, the accident categorizing module 121 tags the traffic video as a traffic accident video with a corresponding one of the pre-determined categories, and stores the traffic accident video and the associated first factoring data in the data storage 11, for example, under a folder in the data storage 11 that is created for the one of the pre-determined categories. In some embodiments, three folders (later referred to as a first folder, a second folder and a third folder, respectively) are created for the above-mentioned first category, the second category and the third category, respectively, but in other embodiments, additional pre-determined categories and folders may be provided.

It is noted that in some embodiments, using the first factoring data, the accident categorizing module 121 may also calculate the associated traffic status of an accident site at which the traffic accident occurred. For example, the associated traffic status may include an amount of traffic (e.g., a large amount, a medium amount, a small amount, etc.), whether traffic congestion is present, whether a violation of traffic rules (by a vehicle or a pedestrian) is present, a number of each type of vehicle, etc.

Then, the method proceeds to step S2, in which the processing unit 12 executing the accident factor mining module 122 processes each of the traffic accident videos stored in the data storage 11.

Specifically, in some embodiments, the accident factor mining module 122 employs a pre-trained neural network for object identification. For example, the neural network may be YOLOv4, a commercially available object detection model, or other suitable neural networks such as YOLOv1, YOLOv2, YOLOv3, a CNN, an R-CNN, a fast R-CNN, a faster R-CNN, etc.

For each of the traffic accident videos, by processing successive images included in the traffic accident video within the accident-related time period associated with the traffic accident and by accessing the associated first factoring data, the accident factor mining module 122 is able to collect second factoring data that is different from the first factoring data. For example, the second factoring data may include one or more of geographical information (e.g., a location, a name of a road, one or more properties associated with the road such as a height limit or a type of the road, for example, a straight road, a curved road, a upward sloped road, a downward sloped road, etc.), information on a road sign (e.g., entry prohibition, one way indication, a speed limit, etc.), weather information (e.g., sunny, cloudy, overcast, drizzle, rainy, foggy, etc.), other special conditions (e.g., road being narrowed, closed, etc.), a time of the day of the time instance (e.g., morning, afternoon, evening, night), etc. Generally, the second factoring data includes information associated with at least the geographical information and/or the weather information.

In embodiments that the driver videos associated with the traffic accident (e.g., the driver video from a corresponding vehicle that is determined to be near the location of the traffic accident within the accident-related time period, or from a vehicle involved in the traffic accident) are available, the accident factor mining module 122 may further process the driver videos and to determine, for each of the driver video, driver data that is associated with a state of the driver. For example, after processing a face image included in the driver video, the determination of the driver data that is associated with a state of the driver may include the accident factor mining module 122 identifying one or more signs indicating that the driver is in a state of mind-wandering, intoxicated, or other states that may be leading to potential traffic accidents. In some embodiments, signs indicating that the driver is in a state of mind-wandering may include excess saccade of the eyeballs related to the movement of the vehicle, an average distance of eyeball saccade detected within a specific driving distance being larger than a predetermined distance, an average staring time of eyeball at a direction that is not parallel to the moving direction of the vehicle within a specific driving distance being larger than a predetermined time), etc. The driver data is then incorporated in the second factoring data.

Afterward, the accident factor mining module 122 is configured to compile a factor group for each of the traffic accident videos based on the first factoring data and the second factoring data. The factor group includes one or more factors that may be associated with the occurrence of the traffic accident. Specifically, using the above example, the accident factor mining module 122 may process a traffic accident video stored under the first folder to compile the factor group by processing the successive images included in the traffic accident video within the accident-related time period, by accessing the associated first factoring data, by collect the second factoring data, and by integrating the first factoring data and the second factoring data. Then, the accident factor mining module 122 stores the factor group in the data storage 11. In some embodiments, some of the exemplary factors may be in the form of: a specific type of road (e.g., a fork in the road or an intersection), specific condition of the road (e.g., going downhill, having an abrupt turn, etc.) specific places (e.g., certain roads with larger traffic), specific time (e.g., 19:00-21:00), a specific range of amount of traffic (e.g., a medium traffic amount), an average velocity of the vehicles, a weather, a number of pedestrians, event(s) of traffic rule violation, etc. In the embodiments that driver videos associated with the traffic accident are available, the state of the driver (e.g., the driver being mind-wandering) may also be included in the factor group.

It is noted that the operations of S2 are done with respect to the traffic accident videos in each of the folders. Each of the traffic accident videos, which is already tagged as one of the three categories, may be then associated with one or more of the above factors to be compiled into an associated factor group. Then, a plurality of factor groups corresponding respectively to the traffic accident videos are compiled and stored in the data storage 11.

Then, the method proceeds to step S3, in which the processing unit 12 executing the sorting module 123 aggregates the factor groups stored in the data storage 11 to create at least one aggregated factor group.

Specifically, the sorting module 123 may be configured to obtain, for each of the categories, one aggregated factor group. In some embodiments, the aggregated factor group may be a group that is a union of all the factor groups (i.e., a group that contains all of the factors indicated in the factor groups).

In some embodiments, the aggregated factor group may be obtained using the following manner. Firstly, the sorting module 123 may obtain all the factor groups stored in the first folder, and use one pre-selected factor (e.g., a type of road) to screen the factor groups stored in the first folder.

In this example, the first folder may store a plurality of traffic accident videos, and the factor group associated with each of the traffic accident videos may include a specific type of road (e.g., a road section with one curve; a road section with multiple curves; an intersection with more than three arms; a road section with multiple lanes converging (or merging) into a reduced number of lanes; or a straight road section with a length greater than a predetermined distance). That is to say, there may be at least one traffic accident video that records a traffic accident occurring on a road section with one curve, or at least one traffic accident video that records a traffic accident occurring on an intersection with more than three arms, etc.

As such, taking “an intersection with more than three arms” as an example, the sorting module 123 may locate all of the traffic accident videos that occur on an intersection with more than three arms, and aggregate all the factors contained in the associated factor groups that correspond to the located traffic accident videos (e.g., an intersection with more than three arms, roads in city, 19:00-21:00, medium traffic amount, a high average velocity of the vehicles, a rainy weather, a larger number of pedestrians, event of jaywalking, etc.), so as to obtain the aggregated factor group. Then, for “a road section with one curve”, another aggregated factor group may be obtained in a similar manner.

In embodiments that the driver videos associated with the traffic accident are available, and taking “a long straight road section” as an example, in addition to the traffic accident videos, the sorting module 123 may further locate all of the driver videos that occur on a long straight road section, and aggregate all the factors contained in the associated factor groups that correspond to the located traffic accident videos and the driver videos (e.g., a long straight road section, freeway, 15:00-16:00, low traffic amount, a high average velocity of the vehicles, a cloudy weather, drivers with signs of mind-wandering, etc.), so as to obtain the aggregated factor group.

In this manner, each of the aggregated factor groups thus obtained may be indicative of a potential traffic accident for a specific scenario. For example, the above aggregated factor group is associated with an intersection with more than three arms, and a potential traffic accident may be attributed to the factors included in the aggregated factor group. When more of the factors are found in a scenario recorded in a traffic video when compared with the aggregated factor group, it may be deduced that an increased probability of occurrence of a traffic accident.

In some embodiments, a fourth category may be included to categorize a near traffic accident event, which, in embodiments, may be referred to as events that nearly result in but in fact do not cause a traffic accident, such as two vehicles coming in very close to each other, a vehicle coming near a pedestrian, a vehicle coming near a wall, etc. It is noted that although no traffic accident actually occurs, one or more factors that are associated with the traffic accident may also be detected that lead to the near traffic accident event. In such cases, the accident categorizing module 121 is configured to identify one or more near accident factors. For example, the near accident factors may include an abrupt velocity drop of one or more vehicles, an abrupt swerve of a vehicle, movements that indicate the vehicle is slipping, etc. In the case that, for a traffic video, one or more near accident factors are identified while no traffic accident is identified, the accident categorizing module 121 may identify a near traffic accident event in the traffic video, categorize the near traffic accident event into the fourth category, obtain the first factoring data associated with the near traffic accident event recorded in the traffic video within an event-related time period associated with a time instance at which the near traffic accident event occurred using a manner similar as described above, tag the traffic video with the fourth category as a near traffic accident video, and store the near traffic accident video and the first factoring data under the fourth folder in the data storage 11.

Then, the accident factor mining module 122 may be executed to collect the second factoring data and to compile a factor group for the near traffic accident video using a manner similar as described above, and to store the factor group under the fourth folder in the data storage 11.

Then, the sorting module 123 may obtain all the factor groups stored in the fourth folder, and use one pre-selected factor (e.g., a downhill road with a curve) to screen the factor groups stored in the fourth folder. The sorting module 123 may locate all of the traffic accident videos that record near traffic accident events occurring on a downhill road with a curve, and aggregate all the factors contained in the associated factor groups (e.g., a downhill road with a curve, in the evening, a high average velocity of the vehicles, a low amount of traffic, drizzle weather conditions, an increase of velocity entering the curve, ill-advised braking, etc.), so as to obtain the aggregated factor group.

As such, the above aggregated factor group is associated with a downhill road with a curve, and a potential traffic accident may also be attributed to the factors included in the aggregated factor group. When more of the factors are identified in a scenario recorded in a traffic video, an increased probability of occurrence of a traffic accident may be deduced.

In some embodiments, the pre-selected factor may be a geographical location (e.g., a specific road section, a specific intersection, etc.), and each of the aggregated factor groups generated by the sorting module 123 may be associated with a corresponding road section or intersection. As such, the sorting module 123 may further create a spreadsheet that contains the aggregated factor groups generated and stored in each of the four folders and that can be sorted using geographical locations. In some embodiments, the spreadsheet may be provided to other parties such as bus fleets, transportation companies or authorities, so as to enable the parties to notify the drivers of the locations that may be prone to traffic accidents of each categories or near traffic accident events.

Additionally, authorities may use the spreadsheet to create alerts on the locations that may be prone to traffic accidents. For example, traffic signs may be created and placed in the locations that may be prone to traffic accidents. Alternatively, when a vehicle approaches a surrounding of a location that may be prone to traffic accidents, the computer device 1 or an electronic device associated with a local authority, in response to receipt of a signal indicating such condition, may transmit a notification to a carputer installed in the vehicle or an electronic device held by the driver via a network (e.g., the Internet, a vehicle-to-everything (V2X) communication, etc.) for notifying the driver of the vehicle of the potential danger in advance. As such, the method of the embodiment of FIG. 1 is completed.

In some embodiments, the processing unit 12 may include additional functional blocks. For example, in some embodiments, the processing unit 12 may include a prediction module 124 that is configured to use the information stored in the data storage 11 (e.g., the spreadsheet) to determine whether a to-be-predicted location is prone to traffic accidents (i.e., to predict whether a traffic accident is likely to occur), based on newly obtained traffic videos after the method of FIG. 1 is completed.

Specifically, in use, a new traffic video may be transmitted to the computer device 1 via the communication unit 13. In response to receipt of the new traffic video, the prediction module 124 is configured to process the new traffic video using a pre-trained neural network similar to that used by the accident categorizing module 121, and to obtain one or more potential factors that are associated with a potential traffic accident. In some embodiments, the potential factors may include factors associated with the first factoring data and the second factoring data obtained in the sorting process, such as geographical information (e.g., location, name of the road, type of road, one or more properties associated with the road such as a height limit, etc.), amount of traffic (e.g., a large amount, a medium amount, a low amount, a traffic congestion, etc.), composition of nearby vehicles (e.g., a percentage of larger vehicles, such as trucks, buses, and semi-trailer trucks, of the vehicles detected in the new traffic video, a percentage of motorcycles of the vehicles detected in the new traffic video, etc.), information on a road sign (e.g., entry prohibition, one way indication, a speed limit, etc.), other objects (e.g., pedestrians, animals, etc.) weather information (e.g., sunny, cloudy, overcast, drizzle, rainy, foggy, etc.), other special conditions (e.g., road being narrowed, closed, etc.), etc. In embodiments that a new driver video associated with the new traffic video is available (a driver video of one of the vehicles presented in the new traffic video), the prediction module 124 may also process the new driver video to mine for the signs of mind-wandering of the driver (e.g., excess saccade of the eyeballs related to the movement of the vehicle, an average distance of eyeball saccade detected within a specific driving distance being larger than a predetermined distance, an average staring time of eyeball at a direction that is not parallel to the moving direction of the vehicle within a specific driving distance being larger than a predetermined time). In the case that the signs of mind-wandering of the driver are identified, the prediction module 124 obtains the signs of mind-wandering of the driver as another potential factor.

After the potential factors are obtained, the prediction module 124 is configured to compare the potential factors and the content of the spreadsheet to calculate a similarity value. In some embodiments, the similarity value may be calculated by determining whether each of the potential factors is present in the spreadsheet, and calculating a percentage of the number of the potential factors that are present in the spreadsheet to the total number of the factors contained in the spreadsheet. As such, a greater similarity value indicates a larger probability of a potential traffic accident.

Using the similarity value, the prediction module 124 may determine whether a surrounding of a location presented in the new traffic video is prone to traffic accidents. For example, when the similarity value associated with the new traffic video is higher than a predetermined threshold (e.g., 0.9), the prediction module 124 may predict that a scenario presented in the new traffic video is prone to traffic accidents, and may generate an alert for the new traffic video.

In some embodiments, the calculation of the similarity value may be done with respect to each of the categories contained in the spreadsheet, and a plurality of similarity values may be calculated (e.g., four). In this manner, when one of the similarity values calculated is higher than the threshold, the prediction module 124 may generate the alert for the new traffic video that specifies the associated category of the potential traffic accident. When more than one of the similarity values calculated are higher than the threshold, the prediction module 124 may generate multiple alerts for the new traffic video that each specify the associated category of the potential traffic accident.

In some embodiments, the alerts may be transmitted using the communication unit 13 to an authority (e.g., a local transportation department). In response to receipt of the alerts, the authority may adopt various measures for preventing the potential traffic accident. For example, traffic officers may be dispatched to the location to direct traffic and/or address the violation. An electronic sign may be employed to display the alert to notify the drivers and pedestrians nearby. Alternatively, when vehicles approach those locations, a notification may be sent to carputers installed in the vehicles or electronic devices held by the drivers for notifying the driver of the potential danger in advance. The above measures may assist in eliminating some of the factors detected in the new traffic video, and therefore reducing the probability of the potential traffic accidents when it is predicted that a scenario presented in the new traffic video is prone to traffic accidents.

It is noted in actual use, numerous new traffic videos may be continuously transmitted to the computer device 1 and processed, and accordingly, numerous new alerts may be generated and transmitted to the authority. In the case that different alerts associated with different similarity values and/or associated with different categories of traffic accidents are received, the authority may adopt different measures for each of the alerts. For example, in response to receipt of a number of different similarity values, traffic officers may be dispatched to the location associated with a highest similarity value. In cases that many high similarity values (e.g., larger than 0.9) are received, the dispatch of traffic officers may be determined based on the categories of traffic accidents. For example, an alert associated with the first category, in which at least one vehicle and at least one non-vehicle moving object are involved, may take priority over an alert associated with the second category, where at least two vehicles are involved. The alert associated with the second category in turn takes priority over an alert associated with the third category, in which a vehicle and a stationary object are involved.

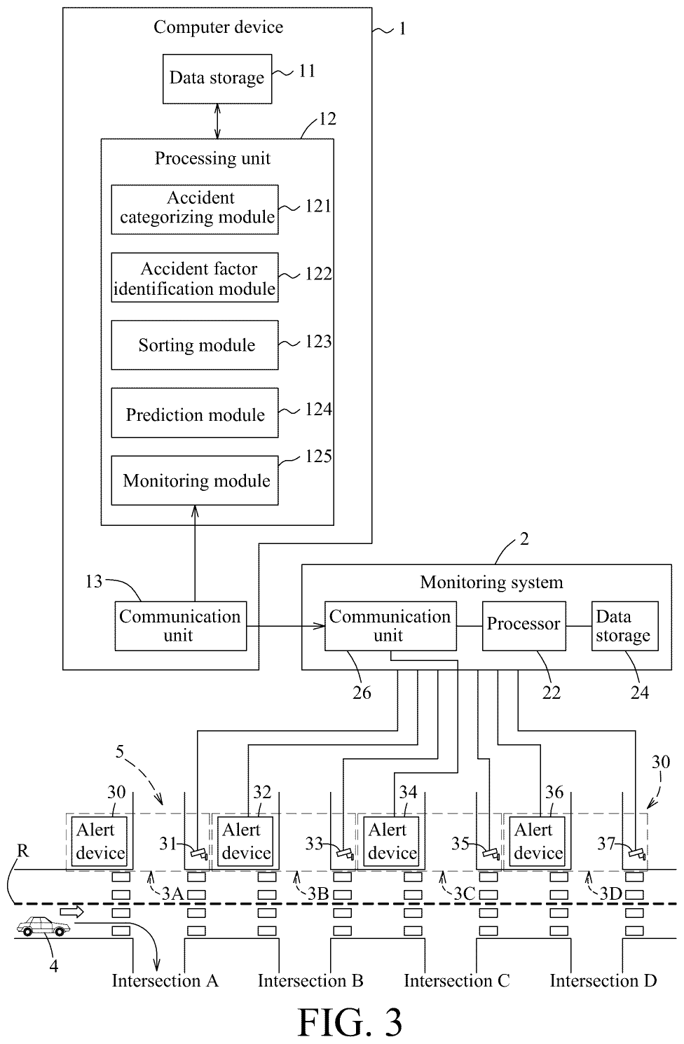

FIG. 3 illustrates the computer device 1 being in communication with a monitoring system 2 according to one embodiment of the disclosure. In this embodiment, the monitoring system 2 may be embodied using a server, a personal computer, a tablet, or other suitable electronic devices, and includes a processor 22, a data storage 24, and a communication unit 26 that may be embodied using components that are similar to the processing unit 12, the data storage 11 and the communication unit 16, respectively. The data storage 24 stores a software application therein that enables the processor 22 executing the software application to perform the operations as described below. Additionally, in this embodiment, the processing unit 12 of the computer device 1 further includes a functional block, that is, a monitoring module 125. In some embodiments, the monitoring module 125 may also employ a neural network for processing traffic videos in a manner similar to the accident categorizing module 121. In some embodiments that some of the vehicles are equipped with the DMS to record the driver videos, the driver videos may also be transmitted to a nearby road monitoring assembly 3 via a wireless communication (e.g., LTE, Wi-Fi, etc.) for processing as well.

The monitoring system 2 is in communication with the computer device 1 and a plurality of road monitoring assemblies 3. In the embodiment of FIG. 3, four road monitoring assemblies 3 (labeled as 3A, 3B, 3C and 3D, respectively) are present, and each of the road monitoring assemblies 3 is mounted in a specific geographical location (e.g., an intersection). Specifically, the road monitoring assemblies 3 are mounted on successive intersections of a same road R (labeled as intersection A, B, C and D, respectively). In this manner, the monitoring system 2 may be able to track the movement of a specific vehicle moving along the road.

Each of the road monitoring assemblies 3 includes a monitoring camera (labeled as 31, 33, 35 and 37 on FIG. 3) that is configured to continuously capture a traffic video, and an alert device (labeled as 30, 32, 34 and 36 on FIG. 3) that is configured to output an alert.

It is noted that in some embodiments, the computer device 1 may be integrated with the monitoring system 2. In some embodiments, one or more of the road monitoring assemblies 3 may further include computer components that include the capability of the computer device 1, and that may be capable of individually processing the traffic video captured by the corresponding monitoring camera.

In use, the traffic videos captured by each of the monitoring cameras are transmitted back to the computer device 1 via the monitoring system 2 for processing by the monitoring module 125. When it is determined that movement of a specific vehicle (e.g., the vehicle 4 of FIG. 3) is abnormal (e.g., swerving, abrupt braking, changing lanes frequently, etc.) based on one of the traffic videos (e.g., one captured by the monitoring camera 31), the monitoring module 125 may then perform a monitoring operation to address the specific vehicle. The monitoring operation involves the monitoring system 2 and one or more of the road monitoring assemblies 3.

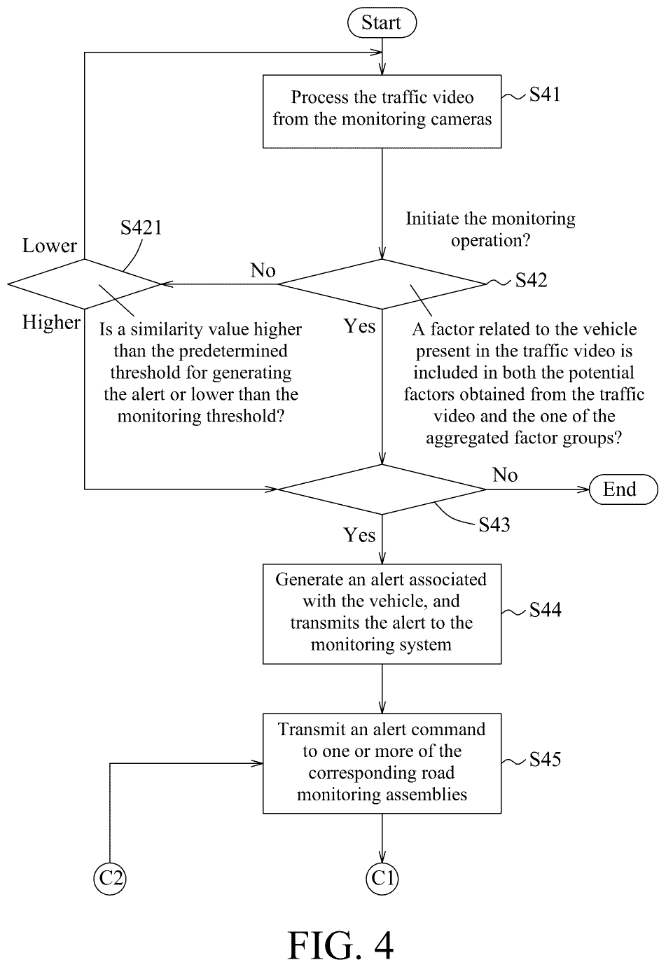

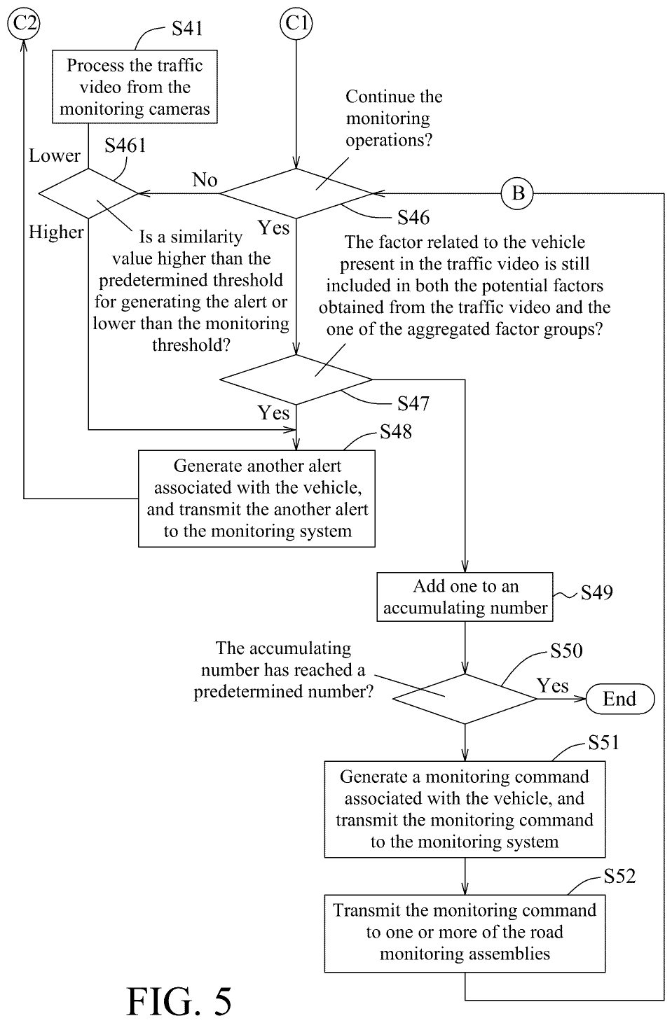

Specifically, FIGS. 4 and 5 are flow charts illustrating steps of a monitoring process according to one embodiment of the disclosure. In this embodiment, the monitoring process is implemented using the computer device 1, the monitoring system 2 and the road monitoring assemblies 3 of FIG. 3.

In step S41, each of the road monitoring assemblies 3 is activated, and the traffic video captured by each of the monitoring cameras are transmitted to the computer device 1. In response to receipt of the traffic videos from the monitoring cameras, the prediction module 124 processes the traffic videos, so as to obtain potential factors associated with each of the traffic videos using a manner similar to the above description related to the prediction module 124. For the sake of clear and concise explanation of the embodiment, steps that are performed with respect to the traffic video captured by one of the monitoring cameras (e.g., the monitoring camera 31) are discussed hereinafter.

In step S42, the prediction module 124 determine whether to initiate the monitoring operation based on the potential factors of the traffic video and one of the aggregated factor groups included in the spreadsheet. For example, the prediction module 124 may compare the potential factors of the traffic video and one of the aggregated factor groups contained in the spreadsheet to calculate a similarity value, and when determining that the traffic video containing the vehicle 4 has a similarity value that is not higher than the predetermined threshold for generating the alert (i.e., 0.9), but higher than a monitoring threshold (e.g., 0.2), the prediction module 124 determines to initiate the monitoring operation. Generally, when the similarity value is within a predetermined range (e.g., about 0.2 to about 0.9), the prediction module 124 determines to initiate the monitoring operation.

In one example, at the intersection A, the prediction module 124 may look up the spreadsheet to access the aggregated factor groups associated with the intersection A. One of the aggregated factor groups (e.g., under the first folder) may include the following factors of: daytime; rainy weather; a large number of pedestrians; an intersection; and a vehicle violating the traffic rules. The prediction module 124 may also obtain potential factors from the traffic video captured by the monitoring camera 31 that includes the following factors of: nighttime; rainy weather; a large number of pedestrians; an intersection; and the vehicle 4 is speeding. As such, a similarity value of 0.8 is calculated, which triggers the monitoring operations. In the case that the determination of step S42 is affirmative, the flow proceeds to step S43. Otherwise, the flow goes to step S421, in which the prediction module 124 determines whether the similarity value is higher than the predetermined threshold for generating the alert or lower than the monitoring threshold. When it is determined that the similarity value is higher than the predetermined threshold, the flow proceeds to step S44; otherwise, when it is determined that the similarity value is lower than the predetermined threshold, no monitoring operation is needed, and the flow goes back to step S41.

In step S43, the monitoring module 125 determines whether a factor related to the vehicle 4 presented in the traffic video is included in both the potential factors obtained from the traffic video and the one of the aggregated factor groups. In the above example, the vehicle 4 is determined to be speeding (based on the potential factors), and the one of the aggregated factor groups includes “a vehicle violating the traffic rules”. As such, the determination is affirmative, and the flow proceeds to step S44. Otherwise, when the determination of step S43 is negative, the monitoring process may be terminated or go back to step S41. In some embodiments where the vehicle 4 is equipped with the DMS to record the driver video, the potential factor related to the vehicle 4 may further include “the driver with signs of mind-wandering” as obtained by the prediction module 124 in step S41, and when the monitoring module 125 determines that the signs of mind-wandering obtained from the driver video are also included in the one of the aggregated factor groups, the flow proceeds to S44 as well.

In step S44, the monitoring module 125 generates an alert associated with the vehicle 4, and transmits the alert to the monitoring system 2. In some embodiments, the alert may include information related to the vehicle 4 such as a moving direction of the vehicle 4, a license plate identifier of the vehicle 4, a color of the vehicle 4, a car model of the vehicle 4, etc.

In response to receipt of the alert, in step S45, the monitoring system 2 transmits an alert command to one or more of the corresponding road monitoring assemblies 3. In the above example, the vehicle 4 is detected to be moving in a right direction (as indicated by the arrow of FIG. 3) along the road R and passing the intersection A. As a result, the monitoring system 2 transmits an alert command to a next one of the road monitoring assemblies (e.g., the road monitoring assembly 3B), to which the vehicle 4 is expected to travel. It is noted that in other embodiments, the alert command may also be transmitted to other road monitoring assembly(ies). For example, in expectation that the vehicle may turn right on the street S on the intersection A (based on clues such as the vehicle 4 being on a right turn lane, having the right turn signal activated, the vehicle beginning to turn right, etc.), the monitoring system 2 may also transmit the alert command to a road monitoring assembly installed on the corresponding section of the street S.

In response to the receipt of the alert command, the alert device 32 of the road monitoring assembly 3B outputs the alert to notify the driver of the vehicles, bikers, and pedestrians near the intersection B of the approaching vehicle 4, and the monitoring camera 33 of the road monitoring assembly 3B captures a traffic video related to the intersection B. Additionally, the traffic video captured by the corresponding monitoring camera 33 is transmitted to the computer device 1 for processing.

In response to receipt of the traffic video from the monitoring camera 33, in step S46, the monitoring module 125 determines whether to continue the monitoring operations. For example, the monitoring module 125 may process the traffic video from the monitoring camera 33, and calculate the associated similarity value. In the case that the associated similarity value is not higher than the predetermined threshold for generating the alert, but higher than the monitoring threshold, the monitoring module 125 determines to continue the monitoring operations.

In one example, at the intersection B, the monitoring module 125 may look up the spreadsheet to access the aggregated factor groups associated with the intersection B. One of the aggregated factor groups (e.g., under the first folder) may include the following factors of: daytime; rainy weather; a large number of pedestrians; an intersection; and a vehicle violating the traffic rules. The monitoring module 125 may also obtain potential factors from the traffic video captured by the monitoring camera 33 that includes the following factors of: nighttime; rainy weather; an intersection; and the vehicle 4 is speeding. As such, a similarity value of 0.6 is calculated, which indicates that the monitoring operations are to be continued. In the case that the determination of step S46 is affirmative, the flow proceeds to step S47. Otherwise, the flow goes to step S461, in which the monitoring module 125 determines whether the similarity value is higher than the predetermined threshold for generating the alert or lower than the monitoring threshold. When it is determined that the similarity value is higher than the predetermined threshold, the flow proceeds to step S48; otherwise, when it is determined that the similarity value is lower than the predetermined threshold, the monitoring operation is no longer needed, and the flow goes back to step S41.

In step S47, the monitoring module 125 determines whether a factor related to the vehicle 4 is included in the potential factors from the traffic video captured by the monitoring camera 33 and the one of the aggregated factor groups. In the above example, the vehicle 4 is determined to be speeding (based on the potential factors), and the one of the aggregated factor groups includes “a vehicle violating the traffic rules”. As such, the determination is affirmative, indicating the vehicle 4 may endanger other vehicles/pedestrians, and the flow proceeds to step S48. Otherwise, when the determination of step S47 is negative, the flow proceeds to step S49.

In step S48, the monitoring module 125 generates another alert associated with the vehicle 4, and transmits the another alert to the monitoring system 2. In some embodiments, the alert may include information related to the vehicle 4 that is similar to that as the alert generated in step S44.

Then, the flow goes back to step S45, in which the monitoring system 2 transmits an alert command to one or more of the road monitoring assemblies 3. In the above example, the vehicle 4 is detected to be moving in the right direction along the road R and passing the intersection B. As a result, the monitoring system 2 transmits an alert command to a next one of the road monitoring assemblies (e.g., the road monitoring assembly 3C), to which the vehicle 4 is expected to travel. In response to the receipt of the alert command, the alert device 34 of the road monitoring assembly 3C outputs the alert to notify the driver of the vehicles, bikers, and pedestrians near the intersection C of the approaching vehicle 4, and the monitoring camera 35 of the road monitoring assembly 3C captures a traffic video related to the intersection C. Additionally, the traffic video captured by the corresponding monitoring camera 35 is transmitted to the computer device 1 for processing.

It is noted that the operations of steps S45 to S48 may continue as long as the determination of step S47 remains affirmative. In the case that the determination of step S47 becomes negative (indicating that the vehicle 4 is no longer violating the traffic rules and/or that the factors detected near the vehicle 4 do not amount to a threat of traffic accident), the flow proceeds to step S49.

In step S49, the monitoring module 125 adds one to an accumulating number N. Then, in step S50, the monitoring module 125 determines whether the accumulating number N has reached a predetermined number. In some embodiments, the accumulating number N has an initial value of zero.

Specifically, in the abovementioned example, when the flow first proceeds to step S49, since the vehicle 4 has been violating the traffic rules while traveling for at least two consecutive intersections, it may be beneficial to keep monitoring the vehicle 4 even when it is determined that the vehicle 4 is no longer violating the traffic rules. As such, in the embodiment of FIG. 5, the predetermined number may be 2 or other positive integers larger than 2, meaning that the flow needs to reach step S49 twice or more without going to step S48 before the monitoring of the vehicle 4 can be stopped. As such, at the first time the flow proceeds to step S49, the accumulating number N is 1, the determination of step S50 is negative, and the flow proceeds to step S51.

In step S51, the monitoring module 125 generates a monitoring command associated with the vehicle 4, and transmits the monitoring command to the monitoring system 2. In some embodiments, the monitoring command may include information related to the vehicle 4, such as the moving direction of the vehicle 4.

Then, the flow proceeds to step S52, in which the monitoring system 2 transmits a monitoring command to one or more of the road monitoring assemblies 3. In the above example, the traffic video captured by the monitoring camera 35 indicates that the vehicle 4 is no longer violating the traffic rules, and the vehicle 4 is detected to be moving in the right direction along the road R and approaching the intersection D. As a result, the monitoring system 2 transmits the monitoring command to a next one of the road monitoring assemblies (e.g., the road monitoring assembly 3D), to which is vehicle 4 expected to travel. In response to the receipt of the monitoring command, the monitoring camera 37 of the road monitoring assembly 3D captures a traffic video related to the intersection D, and the traffic video captured by the corresponding monitoring camera 37 is transmitted to the computer device 1 for processing. It is noted that in this case, the alert device 36 of the road monitoring assembly 3D may or may not be controlled to output the alert as the vehicles, bikers, and pedestrians near the intersection D of the approaching vehicle 4 may no longer be in imminent danger of a potential traffic accident

Afterwards, the flow goes back to step S46, and an affirmative result of the determination leads the flow to step S47. When a result of the determination of step S47 is also affirmative (indicating that the vehicle 4 is becoming dangerous again), the flow proceeds to step S48, and the accumulating number N is reset to 0. Otherwise, the flow proceeds to step S49, and the accumulating number N is added to 2. Then, in step S50, a result of the determination of step S50 is affirmative, and the monitoring process may be terminated or go back to step S41.

To sum up, the embodiments of the disclosure provide a method and a system for automatically obtaining factors related to traffic accidents based on a plurality of traffic videos. In the method, a computer device processes the plurality of traffic videos to determine whether a traffic accident is identified in one of the traffic videos (therefore making the one of the traffic videos a traffic accident video). The traffic accident videos are then categorized into a plurality of predetermined categories based on the nature of the associated traffic accidents, and stored under different folders of a data storage. Then, the computer device obtains one or more factors related to the traffic accidents from each of the predetermined categories, so as to create at least one aggregated factor group. Using the aggregated factor groups, a spreadsheet may be created to contain the factors related to the traffic accidents obtained from the plurality of traffic videos. After the spreadsheet is created, a number of applications may be developed with the spreadsheet. For example, the drivers for the taxi fleets, transportation companies or other organizations may be notified of the potential traffic accidents on specific geographical locations. Additionally, when a new traffic video is received, the computer device may be able to process the new traffic video to determine whether the surrounding of the location of the new traffic video is prone to traffic accidents (i.e., to predict traffic accidents), and, when the determination is affirmative, generate an alert for an authority for taking the suitable measures to reduce the factors detected, therefore prevent the potential traffic accidents. In this manner, the operations of viewing a large number of traffic videos and to detect the details thereof may be done with significantly improved efficiency.

According to one embodiment, there is provided a non-transitory computer-readable storage medium storing instructions that, when executed by a processor of a computer device, cause the processor to perform steps of the method of FIG. 1 and steps of the process of FIGS. 4 and 5.

According to one embodiment, there is provided an application-specific integrated circuit (ASIC) that includes circuit blocks that, when integrated with a computer device, cause the electronic device to perform steps of the method of FIG. 1 and steps of the process of FIGS. 4 and 5.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for automatically obtaining factors related to traffic accidents, the method being implemented using a computer device that includes a processor and a data storage, the data storage storing a plurality of traffic videos, the method comprising:
a) processing, by the processor, each of the plurality of traffic videos so as to determine, for each of the traffic videos, whether a traffic accident is identified therein, and in the case that a traffic accident is identified in one of the traffic videos, categorizing the traffic accident into one of a plurality of pre-determined categories;
b) collecting, by the processor for each of the traffic videos in which the traffic accidents are identified, first factoring data associated with the traffic accident recorded in the traffic video within an accident-related time period associated with a time instance at which the traffic accident occurred, tagging the traffic video as a traffic accident video with the one of the pre-determined categories, and storing the traffic accident video and the associated first factoring data in the data storage;
c) processing, by the processor, each of the traffic accident videos stored in the data storage so as to collect, for each of the traffic accident videos, second factoring data that is different from the first factoring data and that is contained in the traffic accident video within the accident-related time period;
d) compiling, by the processor, a factor group for each of the traffic accident videos based on the first factoring data and the second factoring data, and aggregating the factor groups to create aggregated factor groups; and
e) creating, by the processor, a spreadsheet that contains the aggregated factor groups generated in step d) and that can be sorted using geographical locations.

2. The method as claimed in claim 1, wherein the plurality of pre-determined categories includes a first category, in which at least one vehicle and at least one non-vehicle moving object are involved, a second category, in which at least two vehicles are involved, and a third category, in which a vehicle and a stationary object are involved.

3. The method as claimed in claim 2, wherein:
step a) further includes: in the case that a near traffic accident event is identified in one of the traffic videos while no traffic accident is identified, categorize the near traffic accident event into a fourth category;
step b) further includes collecting first factoring data associated with the near traffic accident event recorded in the traffic video within an event-related time period associated with a time instance at which the near traffic accident event occurred, tagging the traffic video with the fourth category as a near traffic accident video, and storing the near traffic accident video and the associated first factoring data in the data storage;
step c) further includes collecting the second factoring data that is different from the first factoring data and that is contained in the near traffic accident video within the event-related time period; and
step d) further includes compiling a factor group for the near traffic accident video based on the first factoring data and the second factoring data.

4. The method as claimed in claim 1, further comprising:
in response to receipt of a new traffic video, processing, by the processor, the new traffic video so as to obtain a plurality of potential factors associated with a potential traffic accident;
comparing, by the processor, the potential factors and the content of the spreadsheet to calculate a similarity value; and
when it is determined by the processor, using the similarity value, that a surrounding of a location presented in the new traffic video is prone to traffic accidents, generating an alert for the new traffic video.

5. The method as claimed in claim 4, further comprising:
when a vehicle approaches the surrounding of the location presented in the new traffic video and being prone to traffic accidents, transmitting a notification to a carputer installed in the vehicle via a network.

6. The method as claimed in claim 1, the computer device being in communication with a monitoring system, the monitoring system being in communication with a plurality of road monitoring assemblies, each of the road monitoring assemblies being mounted in a specific geographical location and including an alert device for outputting an alert and a monitoring camera for capturing a traffic video, the method further comprising:
f) in response to receipt of a traffic video from one of the road monitoring assemblies, processing the traffic video to obtain potential factors associated with the traffic video, and determining whether to initiate a monitoring operation based on the potential factors of the traffic video and one of the aggregated factor groups included in the spreadsheet;
g) in the case that the monitoring operation is to be initiated, determining whether a factor related to a vehicle presented in the traffic video is included in both the potential factors and the one of the aggregated factor groups;
h) in the case that a result of the determination of step g) is affirmative, generating an alert associated with the vehicle, and transmitting the alert to the monitoring system for enabling the monitoring system to control a next one of the road monitoring assemblies to output the alert, the alert including at least a moving direction of the vehicle;
i) in response to receipt of another traffic video from the next one of the road monitoring assemblies, processing the another traffic video to obtain potential factors associated with the another traffic video, and determining whether to continue the monitoring operation based on the potential factors of the another traffic video and one of the aggregated factor groups included in the spreadsheet;
j) in the case that the monitoring operation is to be continued, determining whether the factor related to the vehicle is still included in both the potential factors and the one of the aggregated factor groups; and
k) in the case that a result of the determination of step j) is affirmative, generating another alert associated with the vehicle, and transmitting the another alert to the monitoring system for enabling the monitoring system to control another next one of the road monitoring assemblies to output the alert, the another alert including at least a moving direction of the vehicle, a procedural flow of the method going back to step i).

7. The method as claimed in claim 6, wherein step f) includes comparing the potential factors of the traffic video and the one of the aggregated factor groups to calculate a similarity value, and initiating the monitoring operation when the similarity value is within a predetermined range.

8. The method as claimed in claim 7, further comprising:
l) in the case that the result of the determination of step j) is negative, adding one to an accumulating number and determining whether the accumulating number has reached a predetermined number, the accumulating number having an initial value of zero, the predetermined number being a positive integer that is larger than two; and
m) in the case that the determination of step l) is negative, generating a monitoring command associated with the vehicle, and transmitting the monitoring command to the monitoring system, a procedural flow of the method going back to step i).

9. The method as claimed in claim 8, further comprising, in the case that the result of the determination of step j) is affirmative, resetting the accumulating number to zero.

10. The method as claimed in claim 1, the data storage storing a plurality of driver videos, each of the driver videos being obtained by a driver monitoring system installed in a vehicle and including a face image of a driver of the vehicle, wherein:
step c) further includes, by the processor, processing each of the driver videos stored in the data storage so as to determine, for each of the driver videos, driver data that is associated with a state of the driver, and incorporating the driver data in the second factoring data,
wherein determining the driver data includes identifying signs indicating that the driver is in a state of mind-wandering, the signs indicating that the driver is in the state of mind-wandering includes one or more of: excess saccade of the eyeballs related to the movement of the vehicle; an average distance of eyeball saccade detected within a specific driving distance being larger than a predetermined distance; and an average staring time of eyeball at a direction that is not parallel to the moving direction of the vehicle within a specific driving distance being larger than a predetermined time.

11. The method as claimed in claim 10, further comprising:
in response to receipt of a new traffic video and a new driver video associated with the new traffic video, processing, by the processor, the new traffic video and the new driver video so as to obtain a plurality of potential factors associated with a potential traffic accident;
comparing, by the processor, the potential factors and the content of the spreadsheet to calculate a similarity value; and
when it is determined by the processor, using the similarity value, that a surrounding of a location presented in the new traffic video is prone to traffic accidents, generating an alert for the new traffic video.

12. A computer device for automatically obtaining factors related to traffic accidents, comprising a processor and a data storage connected to the processor, the data storage storing a plurality of traffic videos, wherein the processor:
processes each of the plurality of traffic videos so as to determine, for each of the traffic videos, whether a traffic accident is identified therein, and in the case that a traffic accident is identified in one of the traffic videos, categorizes the traffic accident into one of a plurality of pre-determined categories;
collects, for each of the traffic videos in which the traffic accidents are identified, first factoring data associated with the traffic accident recorded in the traffic video within an accident-related time period associated with a time instance at which the traffic accident occurred, tagging the traffic video as a traffic accident video with the one of the pre-determined categories, and store the traffic accident video and the associated first factoring data in the data storage, the first factoring data including information associated with one of a vehicle, a pedestrian, a traffic sign and combinations thereof;
processes each of the traffic accident videos stored in the data storage so as to collect, for each of the traffic accident videos, second factoring data that is different from the first factoring data and that is contained in the traffic accident video within the accident-related time period, the second factoring data including information associated with at least geographical information and weather information;
compiles a factor group for each of the traffic accident videos based on the first factoring data and the second factoring data, and aggregates the factor groups to create aggregated factor groups; and
creates a spreadsheet that contains the aggregated factor groups and that can be sorted using geographical locations.

13. The computer device as claimed in claim 12, wherein the plurality of pre-determined categories includes a first category, in which at least one vehicle and at least one non-vehicle moving object are involved, a second category, in which at least two vehicles are involved, and a third category, in which a vehicle and a stationary object are involved.

14. The computer device as claimed in claim 13, wherein, in the case that a near traffic accident event is identified in one of the traffic videos while no traffic accident is identified, the processor further:
categorizes the near traffic accident event into a fourth category;
collects the first factoring data associated with the near traffic accident event recorded in the traffic video within an event-related time period associated with a time instance at which the near traffic accident event occurred, tags the traffic video with the fourth category as a near traffic accident video, and stores the near traffic accident video and the associated first factoring data in the data storage;
collects the second factoring data that is different from the first factoring data and that is contained in the near traffic accident video within the event-related time period; and
compiles a factor group for the near traffic accident video based on the first factoring data and the second factoring data.

15. The computer device as claimed in claim 12, wherein, in response to receipt of a new traffic video, the processor further:
processes the new traffic video so as to obtain a plurality of potential factors associated with a potential traffic accident;
compares the potential factors and the content of the spreadsheet to calculate a similarity value; and
when it is determined by the processor, using the similarity value, that a surrounding of a location presented in the new traffic video is prone to traffic accidents, generates an alert for the new traffic video.

16. The computer device as claimed in claim 15, wherein, when a vehicle approaches the surrounding of the location presented in the new traffic video and being prone to traffic accidents, the processor further transmits a notification to a carputer installed in the vehicle via a network.

17. The computer device as claimed in claim 12, further comprising a communication unit that is in communication with a monitoring system, the monitoring system being in communication with a plurality of road monitoring assemblies, each of the road monitoring assemblies being mounted in a specific geographical location and including an alert device for outputting an alert and a monitoring camera for capturing a traffic video, wherein the processor further:
in response to receipt of a traffic video from one of the road monitoring assemblies, processes the traffic video to obtain potential factors associated with the traffic video, and determines whether to initiate a monitoring operation based on the potential factors of the traffic video and one of the aggregated factor groups included in the spreadsheet;
in the case that the monitoring operation is to be initiated, determines whether a factor related to a vehicle presented in the traffic video is included in both the potential factors and the one of the aggregated factor groups;
in the case that it is determined a factor related to a vehicle presented in the traffic video is included in both the potential factors and the one of the aggregated factor groups, generates an alert associated with the vehicle, and transmits the alert to the monitoring system for enabling the monitoring system to control a next one of the road monitoring assemblies to output the alert, the alert including at least a moving direction of the vehicle;
in response to receipt of another traffic video from the next one of the road monitoring assemblies, processes the another traffic video to obtain potential factors associated with the another traffic video, and determines whether to continue the monitoring operation based on the potential factors of the another traffic video and one of the aggregated factor groups included in the spreadsheet;
in the case that the monitoring operation is to be continued, determines whether the factor related to the vehicle is still included in both the potential factors and the one of the aggregated factor groups; and
in the case that it is determined the factor related to the vehicle is still included in both the potential factors and the one of the aggregated factor groups, generates another alert associated with the vehicle, and transmits the another alert to the monitoring system for enabling the monitoring system to control another next one of the road monitoring assemblies to output the alert, the another alert including at least a moving direction of the vehicle.

18. The computer device as claimed in claim 17, wherein the processor determines whether a factor related to a vehicle presented in the traffic video is included in both the potential factors and the one of the aggregated factor groups by comparing the potential factors of the traffic video and the one of the aggregated factor groups to calculate a similarity value, and initiating the monitoring operation when the similarity value is within a predetermined range.

19. The computer device as claimed in claim 18, wherein, in the case that the monitoring operation is not to be continued, the processor further:
adds one to an accumulating number and determine whether the accumulating number has reached a predetermined number, the accumulating number having an initial value of zero, the predetermined number being a positive integer that is larger than two; and
in the case that it is determined that the accumulating number has not reached the predetermined number, generate a monitoring command associated with the vehicle, and transmits the monitoring command to the monitoring system.

20. The computer device as claimed in claim 18, wherein, in the case that the monitoring operation is to be continued, the processor further resets the accumulating number to zero.

21. The computer device as claimed in claim 12, wherein:
the data storage further stores a plurality of driver videos, each of the driver videos is obtained by a driver monitoring system installed in a vehicle and includes a face image of a driver of the vehicle:
the processor further processes each of the driver videos stored in the data storage so as to determine, for each of the driver videos, driver data that is associated with a state of the driver, and incorporates the driver data in the second factoring data,
wherein the processor determines the driver data by identifying signs indicating that the driver is in a state of mind-wandering, the signs indicating that the driver is in the state of mind-wandering includes one or more of: excess saccade of the eyeballs related to the movement of the vehicle; an average distance of eyeball saccade detected within a specific driving distance being larger than a predetermined distance; and an average staring time of eyeball at a direction that is not parallel to the moving direction of the vehicle within a specific driving distance being larger than a predetermined time.

22. The computer device as claimed in claim 21, wherein, in response to receipt of a new traffic video and a new driver video associated with the new traffic video, the processor further:
process the new traffic video and the new driver video so as to obtain a plurality of potential factors associated with a potential traffic accident;
compare the potential factors and the content of the spreadsheet to calculate a similarity value; and
when it is determined by the processor, using the similarity value, that a surrounding of a location presented in the new traffic video is prone to traffic accidents, generates an alert for the new traffic video.

23. A non-transitory computer-readable storage medium storing instructions that, when executed by a processor of a computer device, cause the processor to perform steps of the method of claim 1.
